(19) United States
(12) Patent Application Publication
(10) Pub. No.: US 2016/0060500 A1
(43) Pub. Date: Mar. 3, 2016

(54) Composition and Methods for Completing Subterranean Wells

(71) Applicant: Slaheddine Kefi, Velizy-Villacoublay (FR)

(72) Inventor: Slaheddine Kefi, Velizy-Villacoublay (FR)

(21) Appl. No.: 14/783,108

(22) PCT Filed: Apr. 9, 2013
(86) PCT No.: PCT/IB2013/001157

§ 371 Date: Oct. 8, 2015

(51) Int. Cl. C09K 8/06; C09K 8/40; C09K 8/42; C09K 8/52

(52) U.S. Cl. CPC C09K 8/06; C09K 8/52; C09K 8/40; C09K 8/424

(57) ABSTRACT

Well treatment compositions comprise at least one surfactant, and an ionic liquid, a deep eutectic solvent or both. When added to spacer fluids, chemical washes or both, the compositions promote the removal of non-aqueous drilling fluids from casing surfaces. Additionally, the treated casing surfaces are water wet, thereby promoting optimal bonding to cement.

### BACKGROUND

The statements in this section merely provide background information related to the present disclosure and may not constitute prior art.

This disclosure relates to compositions and methods for completing subterranean wells, in particular, fluid compositions and methods for completion operations during which the fluid compositions are pumped into a wellbore and make contact with subterranean rock formations.

In the course of completing oil and gas wells and the like, various types of fluids are circulated in the wellbore. These fluids include, but are not limited to, drilling fluids, spacer fluids, cement slurries and gravel-packing fluids. In addition, these fluids typically contain solid particles.

Cement slurries are usually incompatible with most drilling fluids. If the cement slurry and drilling fluid commingle, a highly viscous mass may form that can cause several problems. Cement slurry can channel through the viscous mass. Unacceptably high friction pressures can develop during the cement job. Plugging of the annulus can result in job failure. In all of these situations, zonal isolation may be compromised, and expensive remedial cementing may be required.

Consequently, intermediate fluids called preflushes are often pumped as buffers to prevent contact between cement slurries and drilling fluids. Preflushes can be chemical washes that contain no solids or spacer fluids that contain solids and can be mixed at various densities.

Spacers are preflushes with carefully designed densities and rheological properties. Spacers are more complicated chemically than washes. Viscosifiers are necessary to suspend the solids and control the rheological properties, and usually comprise water-soluble polymers, clays or both. Other chemical components include dispersants, fluid-loss control agents, weighting agents, antifoam agents and surfactants. A thorough discussion concerning the uses and compositions of preflushes may be found in the following publication. Daccord G, Guillot D and Nilsson F: “Mud Removal,” in Nelson E B and Guillot D (eds.): Well Cementing—2^{nd} Edition, Houston: Schlumberger (2006) 183-187. The entire content of the publication, Well Cementing—2^{nd} Edition, is hereby incorporated by reference into the current application.

For optimal fluid displacement, the density of a spacer fluid should usually be higher than that of the drilling fluid and lower than that of the cement slurry. Furthermore, the viscosity of the spacer fluid is usually designed to be higher than the drilling fluid and lower than the cement slurry. The spacer fluid must remain stable throughout the cementing process (i.e., no free-fluid development and no sedimentation of solids). In addition, it may be necessary to control the fluid-loss rate.

Another important function of preflushes is to leave the casing and formation surfaces water wet, thereby promoting optimal bonding with the cement. Achieving water-wet surfaces may be challenging, especially when the drilling fluid has been non-aqueous. Such non-aqueous fluids (NAF) may be oil-base muds or emulsion muds whose external phase is oil-base. For these circumstances, special dispersant and surfactant systems have been developed by the industry. Designing a dispersant/surfactant system for a particular well may be complicated because several parameters must be considered, including the base oil of the NAF, the presence of emulsifiers, the fluid density, bottomhole temperature, presence of brine salts and the chemical nature of the cement system.

### SUMMARY

In an aspect, embodiments relate to well treatment compositions comprising water, at least one surfactant, and an ionic liquid, a deep eutectic solvent or both.

In a further aspect, embodiments relate to methods for treating a subterranean well having at least one casing string, comprising preparing an aqueous spacer fluid, chemical wash or both and adding a well treatment composition to the fluid, wash or both. The composition comprises at least one surfactant, and an ionic liquid, a deep eutectic solvent or both. Then the fluid, wash or both containing the composition are placed in the well such that the fluid, wash or both flow past the external surface of the casing string.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The applicants have discovered improved compositions and methods for removing NAF drilling fluids from casing surfaces and leaving the surfaces water wet. In addition, the compositions may provide improved environmental suitability and compliance with local environmental regulations.

In an aspect, embodiments relate to well treatment compositions. The compositions comprise at least one surfactant, and an ionic liquid, a deep eutectic solvent or both. The surfactant concentration may be between 3 and 90 wt %, or may be between 5 and 50 wt %. The concentration of the ionic liquid, the deep eutectic solvent or both may be between 10 and 97 wt %, or may be between 50 and 95 wt %.

As used herein, ionic liquids shall be defined as salts in the liquid state. More information on ionic liquids can be found in: Welton T: “Room Temperature Ionic Liquids,” Chem. Rev. 99: 2071-2084 (1999), the entire content of which is incorporated by reference into the current application. As used herein, deep eutectic solvents shall be defined as mixtures of materials that are capable of associating with one another to form a eutectic mixture whose melting point is lower than those of each individual component. More information on eutectic solvents can be found in: Zhang Q et al.: “Deep Eutectic Solvents: Syntheses, Properties and Applications,” Chemical Society Reviews, 2012, 41 (21), 7108-7146, the entire content of which is incorporated by reference into the current application.

Water may be included in the compositions. Such inclusion may help prevent phase separation upon storage, thereby improving logistics. In these cases, the compositions may comprise water, at least one surfactant, and an ionic liquid, a deep eutectic solvent or both. The water concentration may be between 10 and 50 wt %, or may be between 10 and 30 wt %. The surfactant concentration may be between 3 and 75 wt %, or may be between 5 and 50 wt %. The concentration of the ionic liquid, the deep eutectic solvent or both may be between 3 and 75 wt %, or may be between 5 and 50 wt %.

The surfactants are chosen according to their hydrophilic-lipophilic balances (HLB). The HLB is determined using either Griffin's method for non-ionic surfactants (scaling from 0 to 20) or Davies' method for anionic surfactants (scaling from 0 to 40). Additional information may be found in the following references. Griffin W C: “Calculation of HLB Values of Non-Ionic Surfactants,” Journal of the Society of Cosmetic Chemists 5 (1954): 249; and Davies J T: “A quantitative kinetic theory of emulsion type, I. Physical chemistry of the emulsifying agent,” Gas/Liquid and Liquid/Liquid Interface. Proceedings of the International Congress of Surface Activity (1957): 426-438. The entire content of the reference, Griffin W C: “Calculation of HLB Values of Non-Ionic Surfactants,” is hereby incorporated by reference into the current application. In the following description, Griffin HLB values are noted as HLBg and Davies HLB values are noted as HLBd.

The surfactant may comprise an anionic surfactant comprising oil-soluble alkaline, alkaline earth metal and amine dodecylbenzenesulfonates, alkylsulfates, alkylsulfonates, alpha olefin sulfonates, alkyl sulfosuccinates, alkyl ether sulfosuccinates, alkyl ether sulfates, alkyl ether sulfonates, carboxylates, lignosulfonates, phosphonate esters, phosphate esters, phosphonated polyglycol ethers, phosphated polyglycol ethers, or combinations thereof, wherein the HLBd value is lower than 30. The HLBd value may be lower than 25. The anionic surfactant may have one, two or three alkyl chains or branched alkyl chains or both. In some embodiments, the anionic surfactant comprises an alkyl sulfosuccinate.

The surfactant may comprise a hydrophilic non-ionic surfactant comprising alkoxylated alcohols, alkoxylated mercaptans, alkoxylated alkylphenols, alkoxylated tristyrylphenols, alkoxylated castor oil, alkoxylated esters, alkoxylated diesters, alkoxylated alkylamines, alkoxylated alkylamides, copolymers of polyalkylene glycol, random sorbitan mono- or polyesters, di-block sorbitan mono- or polyesters, tri-block sorbitan mono- or polyesters, ethoxylated sorbitan monoesters, ethoxylated sorbitan polyesters, betaines, hydroxysultaines, taurines, sarcosinates, alkyl imidazolines, amphoacetates, amphoproprionates, amphosulfonates, alkyl polyglucosides, phosphatidylcholines, lipoamino acids, polypeptides, glycolipids, rhamnolipids, flavolipids, or combinations thereof, wherein the HLBg value is between 7 and 17. The HLBg value may be between 8 and 16. In some embodiments, the hydrophilic non-ionic surfactant comprises an alkyl ethoxylate.

The ionic liquid may comprise alkyl imidazolium compounds, alkyl ammonium compounds, alkyl phosphonium compounds, or combinations thereof. The alkyl portion of the compounds may have a carbon number higher than or equal to 2.

The deep eutectic solvent may comprise a halide salt of a phosphonium or ammonium hydrogen-bond acceptor, or both, and a neutral hydrogen-bond donor. The solvent may comprise choline chloride or derivatives thereof, and another ingredient comprising urea, ethylene glycol, glycerol, trifluoroacetamide, malonic acid, or combinations thereof.

In a further aspect, embodiments relate to methods for treating a subterranean well having at least one casing string, comprising preparing an aqueous spacer fluid, chemical wash or both and adding a well treatment composition to the fluid, wash or both. The composition comprises at least one surfactant, and an ionic liquid, a deep eutectic solvent or both. Then the fluid, wash or both containing the composition are placed in the well such that the fluid, wash or both flow past the external surface of the casing string. Details concerning the various compositional components and compositional ratios have been described previously. The concentration of the composition in the fluid, wash or both may be between 0.25 and 20 wt %, or between 2.5 and 10 wt %.

Further illustration of the disclosure is provided by the following examples.

### EXAMPLES

As discussed earlier, effective NAF removal from casing and wellbore surfaces promotes cementing success. Four laboratory methods were used for evaluating the performance of the disclosed compositions, and the methods pertain to the present examples.

The following method, a rotor test, was employed to evaluate the ability of chemical-wash compositions to remove NAF from casing surfaces. Unless otherwise noted, the chemical wash solutions were prepared by diluting 10 vol % of the surfactant-solvent composition in water. The test equipment was a Chan 35™ rotational rheometer, available from Chandler Engineering, Tulsa, Okla., USA. The rheometer was equipped with two cups—one with an 85-mm diameter for tests conducted at 25° C. and 55° C., and one with a 50-mm diameter for tests conducted at 85° C. Two closed rotors, each 76.4 mm high and 40.6 mm in diameter, were employed to simulate the casing surface and provide an evaluation of test repeatability. Both rotors had sand blasted stainless-steel surfaces with an average roughness of 2 μm.

A NAF was prepared and sheared at 6000 RPM in a Silverson mixer for 30 minutes, followed by a 16-hour aging period in a rolling oven at the desired test temperature. The NAF was then transferred to one of the Chan 35™ rheometer cups. A test rotor was weighted (w₀) and then lowered into the NAF to a depth of 50 mm. The rotor was then rotated within the NAF for one minute at 100 RPM and then left to soak in the NAF for five minutes. Next, the rotor was removed from the NAF and left to drain for two minutes. The bottom of the rotor was wiped clean and then weighed (w₁). The rotor was then remounted on the rheometer and immersed in a cup containing the chemical wash such that the NAF layer was just covered by the chemical wash. The rotor was rotated for 10 minutes at 100 RPM. The rotor when then removed from the chemical wash and left to drain for two minutes. The bottom of the rotor was wiped clean and weighed (w₂). The NAF removal efficiency R was then determined by Eq. 1.

$$R = \frac{{w}_{1} - {w}_{2}}{{w}_{1} - {w}_{0}} \qquad ( Eq . 1 )$$

The tests were repeated at least twice, and the results were averaged to obtain a final result. It is desirable to achieve an R value higher than 75%.

In the present examples, the non-aqueous (NAF) drilling fluid was RHELIANT™, available from M-I SWACO, Houston, Tex., USA. The RHELIANT™ formulation was based on synthetic oil (LAO 16/18 from Ineos Oligomers), with a 75/25 oil/water ratio. The drilling fluid was weighted with barite to a density of 1500 kg/m³ (12.5 lbm/gal).

### Example 1

The following surfactant-solvent blend was prepared in a beaker with a magnetic stirrer, and agitated until the solution was homogeneous.
100 wt % of a blend of ethoxylated alcohols (with HLBg values between 8 and 16) and butoxyethanol, available from Schlumberger.

Rotor tests conducted with the drilling fluid had the following result: R 60%.

### Example 2

The following surfactant-solvent blend was prepared in a beaker with a magnetic stirrer, and agitated until the solution was homogeneous.
50 wt % of a blend of ethoxylated alcohols (with HLBg values between 8 and 16) and butoxyethanol, available from Schlumberger.
50 wt % butoxyethanol

Rotor tests conducted with the drilling fluid had the following result: R=62%.

### Example 3

The following surfactant-solvent blend was prepared in a beaker with a magnetic stirrer, and agitated until the solution was homogeneous.
50 wt % of a blend of ethoxylated alcohols (with HLBg values between 8 and 16) and butoxyethanol, available from Schlumberger.
50 wt % deep eutectic solvent containing 50 wt % choline chloride and 50 wt % glycerol.

Rotor tests conducted with the drilling fluid had the following result: R=95%.

Although various embodiments have been described with respect to enabling disclosures, it is to be understood that this document is not limited to the disclosed embodiments. Variations and modifications that would occur to one of skill in the art upon reading the specification are also within the scope of the disclosure, which is defined in the appended claims.

1. A well treatment composition, comprising:
i. water;
ii. at least one surfactant; and
iii. an ionic liquid, a deep eutectic solvent or both.

2. The composition of claim 1, wherein the surfactant comprises an anionic surfactant comprising oil-soluble alkaline, alkaline earth metal and amine dodecylbenzenesulfonates, alkylsulfates, alkylsulfonates, alpha olefin sulfonates, alkyl sulfosuccinates, alkyl ether sulfosuccinates, alkyl ether sulfates, alkyl ether sulfonates, carboxylates, lignosulfonates, phosphonate esters, phosphate esters, phosphonated polyglycol ethers or phosphated polyglycol ethers or combinations thereof, wherein the HLBd value is lower than 30.

3. The composition of claim 1, wherein the surfactant comprises a hydrophilic non-ionic surfactant comprising alkoxylated alcohols, alkoxylated mercaptans, alkoxylated alkylphenols, alkoxylated tristyrylphenols, alkoxylated castor oil, alkoxylated esters, alkoxylated diesters, alkoxylated alkylamines, alkoxylated alkylamides, copolymers of polyalkylene glycol, random sorbitan mono- or polyesters, di-block sorbitan mono- or polyesters, tri-block sorbitan mono- or polyesters, ethoxylated sorbitan monoesters, ethoxylated sorbitan polyesters, betaines, hydroxysultaines, taurines, sarcosinates, alkyl imidazolines, amphoacetates, amphoproprionates, amphosulfonates, alkyl polyglucosides, phosphatidylcholines, lipoamino acids, polypeptides, glycolipids, rhamnolipids or flavolipids or combinations thereof, wherein the HLBg value is between 8 and 16.

4. The composition of claim 1, wherein the ionic liquid comprises alkyl imidazolium compounds, alkyl ammonium compounds, alkyl phosphonium compounds or combinations thereof.

5. The composition of claim 4, wherein the alkyl portion of the compounds has a carbon number higher than or equal to 2.

6. The composition of claim 1, wherein the deep eutectic solvent comprises a halide salt of a phosphonium or ammonium hydrogen-bond acceptor, or both, and a neutral hydrogen-bond donor.

7. The composition of claim 6, wherein the deep eutectic solvent comprises choline chloride or a derivative thereof and another ingredient comprising urea, ethylene glycol, glycerol, trifluoroacetamide, malonic acid or combinations thereof.

8. A method for treating a subterranean well having at least one casing string, comprising:
i. preparing an aqueous spacer fluid, chemical wash or both;
ii. adding a well treatment composition to the fluid, wash or both, the composition comprising:
a. at least one surfactant; and
b. an ionic liquid, a deep eutectic solvent or both;
iii. placing the fluid, wash or both containing the composition in the well such that the fluid, wash or both flow past the external surface of the casing string.

9. The method of claim 8, wherein the concentration of the composition in the fluid, wash or both is between 0.25% and 20% by weight.

10. The method of claim 8, wherein the surfactant comprises an anionic surfactant comprising oil-soluble alkaline, alkaline earth metal and amine dodecylbenzenesulfonates, alkylsulfates, alkylsulfonates, alpha olefin sulfonates, alkyl sulfosuccinates, alkyl ether sulfosuccinates, alkyl ether sulfates, alkyl ether sulfonates, carboxylates, lignosulfonates, phosphonate esters, phosphate esters, phosphonated polyglycol ethers or phosphated polyglycol ethers or combinations thereof, wherein the HLBd value is lower than 30.

11. The method of claim 8, wherein the surfactant comprises a hydrophilic non-ionic surfactant comprising alkoxylated alcohols, alkoxylated mercaptans, alkoxylated alkylphenols, alkoxylated tristyrylphenols, alkoxylated castor oil, alkoxylated esters, alkoxylated diesters, alkoxylated alkylamines, alkoxylated alkylamides, copolymers of polyalkylene glycol, random sorbitan mono- or polyesters, di-block sorbitan mono- or polyesters, tri-block sorbitan mono- or polyesters, ethoxylated sorbitan monoesters, ethoxylated sorbitan polyesters, betaines, hydroxysultaines, taurines, sarcosinates, alkyl imidazolines, amphoacetates, amphoproprionates, amphosulfonates, alkyl polyglucosides, phosphatidylcholines, lipoamino acids, polypeptides, glycolipids, rhamnolipids or flavolipids or combinations thereof, wherein the HLBg value is between 8 and 16.

12. The method of claim 8, wherein the ionic liquid comprises alkyl imidazolium compounds, alkyl ammonium compounds, alkyl phosphonium compounds or combinations thereof.

13. The method of claim 12, wherein the alkyl portion of the compounds has a carbon number higher than or equal to 2.

14. The method of claim 8, wherein the deep eutectic solvent comprises a halide salt of a phosphonium or ammonium hydrogen-bond acceptor, or both, and a neutral hydrogen-bond donor.

15. The method of claim 14, wherein the deep eutectic solvent comprises choline chloride or a derivative thereof and another ingredient comprising urea, ethylene glycol, glycerol, trifluoroacetamide, malonic acid or combinations thereof.
